(19) United States
(12) Patent Application Publication
(10) Pub. No.: US 2025/0019551 A1
(43) Pub. Date: Jan. 16, 2025

(54) COATING COMPOSITION

(71) Applicant: DAXEM GMBH, Eschborn (DE)

(72) Inventors: Enrico BREGA, Eschborn (DE); Daniele FREGONESE, Hofheim (DE); Claudia M. HAUSOEL, Eschborn (DE)

(21) Appl. No.: 18/577,487

(22) PCT Filed: Jun. 30, 2022
(86) PCT No.: PCT/DE2022/100475

§ 371 Date: Jan. 8, 2024

(30) Foreign Application Priority Data
Jul. 12, 2021 (DE) 10 2021 117 979.3

(51) Int. Cl. C09D 7/61; C09D 5/14; C09D 7/20; C09D 7/48; C09D 7/63

(52) U.S. Cl. CPC C09D 7/61; C09D 5/14; C09D 7/20; C09D 7/48; C09D 7/63

(57) ABSTRACT

The invention relates to a coating formulation with antimicrobial and antivirus properties. The biocidal effect is obtained by an unexpected synergistic action of silver ions together with isothiazolinone derivatives, which allows to reduce the content of biocides in the formulation or to have a more efficient and faster biocide performance. The same formulation also includes a fluorescent component, added to determine the homogeneous distribution of the coating on the treated substrate.

One embodiment of the invention is about a coating formulation applicable by spraying and it contains solvent or co-solvent and propellant.

### BRIEF DESCRIPTION OF THE INVENTION

The subject of this invention is a liquid coating composition characterized by antimicrobial and antiviral properties. The biocidal performance is given by a biocidal- and cost-effective amount of a silver compound, whose antimicrobial and antiviral efficacy is unexpectedly synergically further boosted by adding a minimal and cost-effective quantity of an isothiazolinone derivative.

The coating composition also provides scratch resistance features once applied on the substrate.

Moreover, when applied, the same coating composition does not significantly leach the biocidal components into the environment over time.

The coating composition may include TiO2 anatase to further improve the biocides properties in case of exposition to UV light (activate).

In addition, the coating composition includes, among the others, a component that has a fluorescent emission in the range between 400 nm and 760 nm, and this feature is to determine via irradiation with a simple UV Lamp the homogeneous distribution of the coating on the treated substrate.

### BACKGROUND OF THE INVENTION

The demand for antimicrobial coating is constantly growing. It is triggered by the increased level of urbanization of the population and the constant genetic mutation that undergo pathogenic viruses and bacteria.

The rise of antibiotic-resistant strains of i.e. Salmonella, Escherichia coli, Staphylococcus aureus, and Listeria is a serious global problem, especially when it comes to clinical medicine. In addition, the recent pandemic caused by Covid-19 has shown how important it is to have efficient methods and tools to prevent virus transmission.

Moreover, it is well known that paints and varnishes often have inadequate resistance to the action of microorganisms. Some of these coating compositions, such as enamels and house paints, contain as their resinous binders drying oils, oleoresins varnishes, or alkyd resins, which are subject to attack by fungi and bacteria that can then proliferate and thus enhance the risk of infection.

Moreover, the pandemic that unfolded in early 2020 has forced doctors to react in a way that could lead to a rise in superbugs infections. In fact, it is reported that antibiotics were given to more than half of patients admitted to hospitals with Covid-19 in the first half of last year during the pandemic.

In addition, recently released research [1] shows that 52% of hospital admissions linked to Coronavirus resulted in at least one antibiotic prescription, and 36% of the cases to multiple prescriptions. That raises new concerns over the spread of drug resistance (superbugs) linked to over-prescription. That is just one of the reasons why, now more than ever, there is a need for efficient and easy to use antimicrobial coatings for surfaces exposed to possible contact with viruses and bacteria, to reduce the human to human transmission.

Another issue is presented by the fact that the process of treating a surface with an antimicrobial coating can leave the spots of substrate uncoated and exposed to contamination. That could also be due to the wear off effect linked to environmental conditions or mechanical abrasion. The challenge is to timely identify the not coated spots, therefore exposed to bacterial and/or virus contamination.

It is at this point important to mention that the coating industry is under extreme pressure to reduce formulation cost as much as possible to maintain the economic profitability that used to characterize the entire sector.

In other words: the market and the scientific communities are constantly looking for coating solutions that are easy to use, more effective and with a better cost structure than current options available on the marketplace.

This invention is concerned with the biocidal properties of silver ions, still, it is not limited to. The antimicrobial features of silver and some of its derivatives have been known for centuries [2]; in fact, it has been widely used in medicine to treat bacterial infections since the 19th century until the discovery and development of the first modern antibiotics in the 1940s.

Silver nitrate has been used in eye drops to treat neonatal eye infections. In stick form, silver nitrate and silver chloride have been used to treat warts and in lotions to treat lesions. In addition, silver nitrate combined with ammonia has been used as an antimicrobial dental protective. Several other silver salts such as acetate, citrate, lactate, picrate and methylene bis naphthalene sulfonate have found use in different therapeutic compositions, such as eye lotions, dust powder for wounds, in astringents and antiseptic, in treating vaginal trichomoniasis and candidiasis and in treating burns, varicose ulcers and pressure sores.

Silver protein complexes have also been widely used in preparations such as creams, lotions and ointments. A sulfonamide derivative, silver sulphadiazine, has successfully treated burns and acute and chronic wounds in creams and lotions. However, there have been reports of microbes in hospital settings developing resistance to sulphadiazine, thus limiting its widespread use.

Although the precise mode of action of silver salts in killing microbes is yet to be established and remains an active research topic; it is known that silver ions react with cellular components (proteins, membranes, DNA) and react particularly fast with DNA and RNA portion of a cell with detrimental effects on microorganism integrity and biochemical functions, with comparatively minimal toxicity to mammalian cells.

It is also scientifically assessed that silver ions can indirectly damage the cell by generating reactive singlet oxygen species, which lead to the formation of hydrogen peroxide [3].

Moreover, it has also been confirmed that metallic silver is an effective antimicrobial, whether in thin films, nanoparticles, or colloidal silver. Chemical compounds, such as silver phosphate, silver norfloxacinate and silver nitrate, are maybe the most well-known effective silver-based antimicrobials.

Despite the plethora of studies and scientific papers on silver ions biocidal features, studies show that silver is not effective in certain conditions. The related literature reports three main conditions that can determine a compromised antimicrobial action.

Silver salts, for instance, bind with particular strength to a variety of organic molecules such as carboxylic acids, thiols, phenols, amines, phosphates and halogenated compounds [4]. However, following the binding, the silver ions are not anymore available for biocidal activity.

It has also been reported a silver resistance [5] developed by certain bacterial and linked to the presence of a binding protein, the flagellum protein [6], which binds the silver ions.

In this case, the silver resistance evolves without any genetic changes; only phenotypic change is needed to reduce the nanoparticles colloidal stability and thus eliminate their antibacterial activity by preventing free radical damage to bacterial DNA.

In this case, the resistance mechanism cannot be overcome by additional stabilization of silver nanoparticles using surfactants or polymers, as suggested in the past.

Moreover, a third reason, almost obvious, why silver ions may not be compelling lies in the concentration; in fact, a highly infected environment requires a high concentration of ions, and in some cases, the solutions available on the market have a too low concentration to be biocidal active. Scientists have found ways to avoid the ineffectiveness of silver ions; for instance, in the patent application from Jampani, Hanuman, B. [7] is reported an antimicrobial composition that controls or prevents resistance to antimicrobial effectiveness. The compositions comprise an antimicrobial agent in combination with antioxidant agents that block intrinsic or acquired bacterial resistance.

The issue of silver ions resistance has also been tackled by some other authors [8] by using particular substances that act as resistance inhibitors. Without wishing to be bound by the theory, it is believed that these substances are able to promote the transport of silver ions across the cell wall and disrupt the ion pump mechanism that is essential for the cells. More in detail, the resistance inhibitors act by modifying the permeability of the microorganism's membrane, for example, by physical disruption or by modifying the type and nature of phospholipids present in the membrane. Among the most commonly used resistance inhibitors, it is worth to mention the ionophore monensin and other carboxylic ionophores (e.g. salinomycin and Lasalocid). Furthermore, calcium channel activators such as dihydropyridine, benzoilpyrrole and maitotoxin may also be effective. In addition, the enzymes phospholipase A2 and triacylglycerol hydrolases and the cationic peptides CAP18 can control cells resistance versus silver ions [9].

As said before, scientific literature reports many coating formulations with biocidal activity due to the presence of silver ions. However, very little has been written about the possible leaching of silver ions by applied coating.

One method to prevent leaching of the biocidal agents in the environment is by embodying the silver ions in a glassy matrix by using sol-gel technology. An example is the patent application of De Xian Wang et al. [10], which discloses the dispersion of metal ions in a silica sol that also contains TiO2; the sol is then applied as a coating and sintered to obtain a glassy transparent coating with antibacterial features.

However, the disadvantage of the proposed solution is that it requires a cumbersome heating treatment in a furnace, which prevents its application in many sectors where it is impossible to sinter the coating on the substrate, or in general, to apply any heat.

A person skilled in the art to which the invention pertains knows that another significant problem that formulators for coatings face most of the time is the necessity to reduce the cost of the formula. In this regard, a way to reach the scope would be to reduce as much as possible the silver content, which is very often the most expensive component in the coating formulation, to sub-biocidal level and to add a molecule that acts as a booster for the silver performance.

To the best of the knowledge of the authors of this patent application, there are very few examples of boosters for biocidal activity against bacteria and fungi and none that describe a synergistic effect of biocides towards the virus. An interesting example is the patent application of Thomas Zahn [11], which describes a synergic effect of isothiazolinone derivatives and a quaternary ammonium salt.

Moreover, I. Sok Hwang [12] describes in a scientific article the synergic effect of antibiotics on silver nanoparticles biocidal performance. Another interesting patent application that is important to mention is the one from Downey Angela Bridget et al. [13], which discloses the synergistic effect of 2-methyl-3-isothiazolinone on the biocidal performance of 2-n-octyl-3-isothiazolinone, and vice-versa. However, this patent application does not relate to a specific coating formulation. David Oppong, in a US patent application [14], discloses synergistic biocide compositions, which are combinations of 1,2-benzoisothiazole in-3-one (BIT) and an iodopropargyl compound (iodopropynyl compound). For example, 3-iodopropargyl-N-butylcarbamate is mentioned as one such compound.

Elsewhere, Dagmar Antoni-Zimmermann has reported [15] a synergetic biocidal composition in which the biocidal performance of 2-methylisothiazolinone-3-one is boosted by the addition of a relatively small amount of a biocide such as polyhexamethylene biguanite, N-hydroxymethyl-1,2-benzoisothiazolin-3-one, benzalkonium chloride, pyridione. However, this patent application does not describe the combination of any of the above mentioned biocides with silver ions or nanoparticles.

Moreover, this patent application also relates to a coating composition containing TiO2 to enhance the biocides performance. Several studies report the use of TiO2 in anti-bacteria coating, although, to the best of the authors' knowledge, none of those coatings has been claimed effective against virus. It is known since 1985 [16] that TiO2 particles with the anatase (rutile is not active) crystalline form are activated by photoexcitation, thereby generating electrons from the valence band migrate to the conduction band, creating electron deficiencies, also referred to as holes, in the valence band. Thereby generating reactive singlet oxygen species, including hydroxyl radicals, hydrogen peroxide, and superoxide ions.

Such ions target bacteria and other microbes via peroxidation and disruption of phospholipids and lipopolysaccharides within bacterial cell membranes.

This patent application also relates to a coating composition containing a fluorescent molecule. The use of fluorescent molecules in coating is well known and already reported. The patent application filed by Dainippon Toryo KK [17] in which is described a paint with a fluorescent component that provides a brilliant colour to the treated substrate even if it is not wholly formed as a white underlayer. However, the authors of this patent application haven't found any prior art that describes the use of a fluorescent molecule included specifically in an antibacterial coating.

A coating can, over time, be worn off because of friction, harsh environmental conditions or weathering conditions. Therefore, it is extremely important to have accurate and easy monitoring of the quality of antimicrobial coating when the coating is transparent, especially in a medical environment.

The present application proposes using fluorescent molecules, whose presence could be detected via a simple lamp with emission spectrum in the range of 340 nm-440 nm. In this case, the appearance of fluorescence spots in the visible part of the electromagnetic spectrum (380-760 nm) is a confirmation that the coating is still on the substrate; therefore, the treated surface is still antimicrobial active.

### DETAILED DESCRIPTION OF THE INVENTION

The authors of the present invention acknowledge that there is a large number of patent applications describing coating formulations with biocidal properties and containing silver ions. However, the coating composition here proposed has silver ions, whose antimicrobial properties are boosted by adding another component, which is an isothiazolinone derivative.

More in detail: in accordance with this invention, it has been surprisingly found that isothiazolinone derivatives boost the biocidal performance of silver ions in regard to yeasts, bacteria and viruses, even when the silver concentration in the matrix is extremely low and below a reasonable and sufficient biocidal activity.

Moreover, the authors have surprisingly discovered that the combination of the microbial components also enhances the anti-scratch properties of the coating. Without wishing to be bound to the theory, the authors believe that the unexpected benefits regarding the mechanical properties are due to the combination of the crosslinking properties of the two biocides, which lead to the formation of a stable and robust network. The formation of the network is also responsible for the low leaching of silver ions, even under harsh conditions, which translates to better durability of the coating.

In the present invention, silver is incorporated into the coating composition as silver element, i.e., Ag.sup.0) or in higher oxidation state silver ions, i.e., Ag.sup.1+, and is provided in silver solutions. The silver compound particles have a particle size that is between 150 nanometers and 6000 nanometers, preferably from 500 to 3000 nanometer and more preferably from about 1500 to 2500 nanometer, with D90<5 μm.

Suitable examples of the silver compounds include silver carboxylates such as silver formate, silver acetate, silver oxalate, silver malonate, silver benzoate, and silver phthalate; silver fluoride, silver chloride, silver bromide, silver phosphate, silver iodide and the like; silver sulfate, silver nitrate, silver carbonate any combination of any of the foregoing. Commercially available silver compounds include, but are not limited to, Silver Phosphate glass from Sanitized AG and sold under the brand name Sanitized, Silvadur™ 900, Silvadur 930, Silvadur 961 and Silvadur ET from The Dow Chemical Company, and the silver derivatives from BASF sold under the brand name Irgaguard.

The silver content in the coating composition ranges from 0.01% w/w up to 10.0% w/w, preferably from 0.05% to 8% w/w and more preferably from about 0.1% to 4% w/w.

As previously said, the preferred silver performance enhancers are the isothiazolinone derivatives, whereby isothiazolinone derivatives is meant any compounds containing the isothiazole nucleus. In particular, the present invention relates to the use of at least one halogen-free isothiazolinone such as 2-n-octyl-4-isothiazolinone-3-one, 2-octyl-isothiazonol-3-on, 2-octyl-2h-isothiazol-3-on, N-butyl-1,2-benzisothiazolin-3-one and 2-methyl-4,5-trimethylene-4-isothiazolin-3-one and/or salts thereof.

The isothiazolinone derivative may contain stabilizing amounts of copper (II) ions as stabilizer. The content of isothiazolinone in the coating formulation ranges between 0.01% to 2% w/w, preferably 0.1% to 0.4% w/w, more preferably from 0.2% to 0.35% w/w.

The coating formulation may also contain TiO2 anatase to enhance the biocide features of the coating. Suitable examples of the TiO2 anatase, but are not limited, include VLP 7000, CristalACTiV™ PC500 manufactured by Crystal Global and Aeroxide® P25 manufactured by EVONIK Degussa Industries.

The content in the coating composition in TiO2 ranges from 0.01% w/w up to 5.0% w/w, preferably from 0.05% to 2% w/w and more preferably from about 0.10% to 1.5% w/w.

The coating composition may be non-aqueous or aqueous, and it may water-like or viscous. The viscosity may be needed to avoid the settlement of the silver particles during storage and to make easier the application of the solution to the substrate. The waterborne coating composition has a viscosity of greater than 80 mPas, preferably greater than 200 mPas. The viscosity was measured with a Brookfield RTV, with spindle 20 or spindle 15 at 25° C.

The non-aqueous formulation, solvent-based, is suitable for aerosol, and it contains organic solvents, resin, pigments (in case of colored coating), coalescing or film-forming solvents, drying agents, thickeners, surfactants, anti-skinning agents, plasticizers, martensitic agents, anticorrosion agents, antiflooding, silver compounds, isothiazolinone and propellant. The most commercial solvent-based aerosol formulation contains mixtures of low molecular weight hydrocarbons as the propellant gas, and the same solutions have been implemented for this invention. Most commonly, a blend of propane and isobutane is used.

As aerosol, liquid propellants, it is worth mentioning ethylene glycol monopropyl ether, isobutyl acetate, methyl acetate, cellulose acetate butyrate, dipropylene glycol methyl ether, ethylene glycol ether, butyl acetate, and dimethyl ether (DME). The latter two are preferred because they have a lower toxicity profile for humans and the same performance as the formers. The formulation typically comprises from about 20% to about 50% w/w and preferably from about 20% to about 30% w/w of propellant added to the formulation.

The method to add the propellant to the mixture may be as follows. After the mixture is introduced in the can, the container is vacuumed, and the propellant is just injected, and the can is then sealed. The coating composition may also include an adhesion promoter to improve the adhesion on surfaces like TPO and PP, which are characterized by low polarity, it is advisable to use an adhesion promoter like AP-550 from Eastman (25% w/w xylene).

It is important to point out that solvent-based coatings have a tendency to sag or run down when the coating is applied to inclined and particularly vertical surfaces. This is particularly true in the case of high solids coating formulations, which are becoming increasingly important with the need to reduce the coatings' Volatile Organic Compound (VOC) content.

There is thus a clear need for rheology modifying agents which reduce the tendency of coatings to sag.

Ideally, such rheology modifying agents should impart structural properties on the coating, such as high viscosity under low shear conditions to inhibit sag after application of the coating and low viscosity under high shear to permit flow and levelling of the coating during application.

The resins suitable for the application ranges from silicone modified alkyd, acrylates and epoxy, nitro cellulose, polyesters, and vinylesters, among the others. Some examples of resins include acrylates, diacrylates, triacrylates, or multifunctional acrylates constitute the cross-linkable group and polymerized via radical polymerization. Examples of Silicone modified resins are like those supplied by Reichhold Chemicals and from The Dow Chemical. Products range or the pure acrylic products like the Elvacite from Dupont, Acronal from BASF.

Other suitable polymeric rheology modifiers include, but are not limited to, hydroxypropyl cellulose, hydroxypropyl methylcellulose, fumed silica, precipitated silica and any combination of any of the foregoing. Preferred rheology modifying agents are polyacrylates and hydroxypropyl cellulose. The composition typically comprises from about 0.05% to about 5% w/w and preferably from about 0.1% to about 1% w/w of polymeric rheology modifier.

In the case of formulation with high content in organic solvents, the coating formulation may include evaporation retardants such as silicon fluid, water-based wax emulsion, paraffin oil, paraffin wax, and any combination of the foregoing.

Most of the times, a surfactant or a mix of surfactants is needed as a solubiliser-emulsifier and also to prevent phase separation during the storage of finished products. The surfactants considered in this patent application are nonionic surfactants such as Triton X-15 (Octylphenoxy polyethoxy ethanol) from The Dow Chemical, Novelusion 333 from Sasol, Capstone FS-31 from Chemours.

Other emulsifiers include, but are not limited to, fluorinated alkyl esters, polyethoxylated sorbitan monooleate, trioleate polysorbates, any combination of any of the foregoing. The composition typically comprises from about 0.1% to about 7% w/w and preferably from about 0.1% to about 2% w/w of surfactant or emulsifier.

The coating formulation may contain organic solvents. A list of suitable solvents includes hexane, heptane, THF, hydrofurane, mineral oil, xylene, toluene, acetone, diethylene glycol, butanone, ester of acrylic and/or methacrylic acid with alkanols containing 1 to 12 C atoms, vinyl chloride, vinylidene chloride, vinyl acetate, vinyl propionate, vinyl esters of versatic acid, vinyl esters of long-chain fatty acids.

The coating composition may also include an aromatic hydrocarbon co-solvent to improve the stability of the mixture, thereby increasing the shelf life of the composition. The aromatic hydrocarbon co-solvent may be a mixture of one or more aromatic hydrocarbon solvents.

Suitable aromatic hydrocarbon co-solvents include, but are not limited to, Aromatic 200Nd from Exxon, metaphenoxy benzyl alcohol, xylene and any combination of any of the foregoing. The composition typically comprises from about 0.5 to about 40% w/w, preferably from about 1% to about 20% w/w, and more preferably from 1% to 5% w/w of aromatic hydrocarbon co-solvent.

The coating composition has a solid content between 0.3% (w/w) and 60% w/w.

In the case of an aqueous formulation, the coating formulation was thickened by commonly used thickeners such as polyacrylates or derivatives or thickeners based on polysaccharides, e.g. xanthan gum, or cellulose derivatives. The aqueous coating formulation can have an associative thickener modified with a hydrophobic oligomer. In this case, the coating formulation is suitable for industrial applications that require a highly shear-thinning rheology profile and high sag resistance, such as spray applied metal coatings on vertical surfaces.

Among the associative thickeners suitable for this invention, the authors have tested polyethylene oxide urethane based associative thickeners (HEURs) that have provided good flow and levelling they provide to the paint, coupled with acceptable sag resistance.

The present invention also considers the use of other associative thickeners comprising as basic polymer: hydroxyethyl cellulose, hydroxypropyl cellulose, methylcellulose, polyethylene oxide, ethyl hydroxyethyl cellulose, carboxymethyl cellulose, guar gum, starch, starch ethers, particularly hydroxyethyl starch, locust bean gum, pectin, xanthan gum, methylhydroxyethyl cellulose, polyvinylpyrrolidone, polyvinyl alcohol, methylhydroxypropyl cellulose, mixed ethers of the above cellulose derivatives and mixtures thereof.

Especially preferred are hydrophobically modified hydroxyethyl cellulose, hydrophobically modified methylhydroxyethyl cellulose, hydrophobically modified hydroxypropyl cellulose, hydrophobically modified polyethyleneglycol-, particularly hydrophobe end-capped polyethyleneglycols. Preferred are dodecyl- and cetyl-modified polymers, e.g. polyethyleneoxides.

Preferred thickeners are disclosed, e.g. in patent applications filed by Acqualon [13, 14]. Furthermore, starch and its derivatives are associative thickeners that can advantageously be used according to the invention.

The thickener content is meant to be from 0.05% to 5.0 w/w, preferably 0.075 to 3.5 wt % and more preferably 0.1% to 3.0% w/w.

The coating formulation may contain suitable mineral fillers include alkaline earth metal oxides. And, carbonate fillers such as calcium carbonate, dolomite and/or aragonite are also preferred with the water-borne coating composition of the present invention. The function of such fillers is to reduce cost formulation and/or to increase viscosity and provide sag resistance.

In general, the coating formulation can be colorless or colored: in the former case suitable pigments can be included.

Suitable pigments are titanium dioxide (rutile), iron oxide, zinc oxide, chromium oxide, cobalt oxides, mixed oxides of cobalt and aluminium, for example, cobalt blue, phthalocyanine pigments, spinel pigments, for instance, spinels of cobalt with nickel and zinc, as well as spinels based on iron and chromium with copper, zinc and manganese, nickel and chromium titanate, manganese titan rutile, mixed rutile phases, bismuth vanadate, ultramarine blue and sulfides of the rare earths.

Preferred pigments comprise, for example, titanium dioxide, zinc sulphide, zinc oxide, soot, iron oxide, chromium oxide, cobalt blue, barite, nickel titanate, phthalocyanine pigment, spinel pigment, and/or chromium titanate.

The inorganic pigment content is meant to be from 0.005% to 3.0% w/w, preferably 0.075% to 1.5% w/w.

Organic pigments are suitable too, and the list includes monoazo pigments, diazo pigments, diazo condensation pigments, anthrachinone pigments, anthrapyrimidine pigments, chinacridone pigments, diketopyrrolopyrrol pigments, dioxazine pigments, flavanthrone pigments, indanthrone pigments, isoindoline pigments, isoindolinone pigments, isoviolanthrone pigments, perinone pigments, perylene pigments, phtalocyanine pigments, pyranthrone pigments, pyrazolochinazolone pigments, thioindigo pigments, triarylcarbonium pigments and mixtures thereof.

Among organic coloured pigments, use can, for example, be made of C.I. Pigment Blue 15, C.I. Pigment Blue 15:1, C.I. Pigment Blue, 15:2, C.I. Pigment Blue 15:3, C.I. Pigment Blue 15:4, C.I. Pigment Blue 15:6, C.I Pigment Blue 16, C.I. Pigment Green 7, C.I. Pigment Green 36, C.I. Pigment Orange 36, C.I. Pigment Orange 43, C.I. Pigment Orange 73, C.I. Pigment Red 122, C.I. Pigment Red 168, C.I. Pigment Red 179, C.I. Pigment Red 188, C.I. Pigment Red 254, C.I. Pigment Red 264, C.I. Pigment Red 282, C.I. Pigment Violett 19, C.I. Pigment Violett 23, Pigment Yellow 74, Pigment Yellow 83, Pigment Yellow 97, C.I. Pigment Yellow 110, C.I. Pigment Yellow 138, C.I. Pigment Yellow 154 or any mixtures of these pigments.

The organic pigment content is meant to be from 0.005% to 3.0% w/w, preferably 0.075% to 1.5% w/w.

The present invention also relates to a coating composition comprising at least one fluorescent additive that absorbs light with a wavelength less than about 500 nanometers and fluoresces the light in the visible part of the spectrum, which is intended 400-760 nm.

Suitable molecules, and not limited to, are Fluorol green Gold, 2-Duil ASP, 4-dimethylamino 4-nitrostilbene, 9-Cyanoanthracene, carboxynaphtofluorescine, zinc tetramesitylprophyrine, QpyMe2, magnesium tetraphenyl porphyrine, and coumarine 6.

To verify the homogeneity of coating application on the substrate, suitable lamps for the listed fluorescent molecules are used. Therefore, the authors have qualified the following lamps: Phoseon FJ100 365, Phoseon FJ100 385, Phoseon FJ100 395, and Phoseon FJ100 405.

### Biocidal Efficacy on Bacteria and Fungi

To quantify the synergic effect of isothiazolinone on silver particles biocidal performance, the authors have developed the following test.

Six simple coating formulations plus a control formulation have been developed and then applied on aluminum metallic plates. The coating solutions have been prepared by first dispersing the carboxymethyl cellulose in water by means of a mixer at high shear (TDS Conti mixer type). Then the isothiazolinone and silver phosphate are added, and the dispersion is kept under stirring for 20 minutes.

The application of the coating solution is conducted by dip coating (dipping speed 0.3 cm/s) on square aluminum plates (5 cm length, 5 cm width and 0.1 cm thickness). The plates were then dried at room temperature for 24 hours.

The plates antimicrobial features have been then tested according to ISO test method 22196 with the following species of bacteria:

Staphylococcus aureus
ATCC 6538P, CIP 53.156, DSM 346,
NBRC 12732, NCIB 8625
AND
   Escherichia coli
ATCC 8739, CIP 53.126, DSM 1576,
NBRC 3972, NCIB 8545

The procedure for the test was as follows.

First, a thin liquid film containing the bacteria (1.25×104 CFU/cm²) is applied directly to the test sample (5 cm×5 cm). Then, to avoid desiccation, a foil (4 cm×4 cm, Stomacher Bags) is applied. Immediately after inoculation, the bacteria from the reference sample are separated from the sample and the enveloping foil surfaces using ultrasound and vortex devices and the number of viable germs (CFU—colony-forming unit) is determined (t0 value). Next, a further set of reference samples have been given antimicrobial treatment, then are incubated with bacteria in a liquid-film and the enveloping foil in a damp environment at 37° C. After a minimum of 24 hours, the bacteria are separated from the sample surfaces using ultrasound and vortex devices, and the number of viable germs is determined (t24 value).

A and D are formulations with only silver, whereas formulation B and E have only isothiazolinone and formulation C and F have both the biocides. In the case of formulation F, the content in isothiazolinone and silver are well below the efficacy biocidal threshold.

TABLE 1
Formulations composition

| | | | | | | | G |
|---|---|---|---|---|---|---|---|
| | A | B | C | D | E | F | Control |
| Tap water | 98.50% | 98.5% | 98.50% | 98.50% | 98.5% | 98.50% | 98.50% |
| 2-Octyl-2H- | 0.0% | 0.05% | 0.05% | 0.0% | 0.025% | 0.025% | 0.0% |
| Isothiazol-3-one | | | | | | | |
| Silver | 1.0% | 0.0% | 1.0% | 0.5% | 0.0% | 0.5% | 0.0% |
| phosphate glass | | | | | | | |
| Sodium | 0.5% | 0.5% | 0.5% | 0.5% | 0.5% | 0.5% | 0.5% |
| carboxymethyl | | | | | | | |
| cellulose | | | | | | | |

Test results:

TABLE 2

| Biocidal performance | | | |
|---|---|---|---|
| expressed as bacterial | Escherichia | Staphylococcus | |
| removal (%) | Coli | Aureus | Yeast |
| Formulation A | 90% | 87% | 20% |
| Formulation B | 40% | 32% | 65% |
| Formulation C | 99.7% | 99.6% | 90% |
| Formulation D | 80% | 71% | 12% |
| Formulation E | 30% | 28% | 48% |
| Formulation F | 99.8% | 98.9% | 84% |
| Formulation G (control) | 2% | 6% | 1% |

The results clearly show that the combination of the two components, silver phosphate and 2-Octyl-2H-Isothiazol-3-one, synergistically and surprisingly enhance the antibacterial and antifungal performance of the coated plates. More in detail, the table shows that a concentration in silver in the range of 0.5% w/w is below the threshold of biocidal activity, but performance is strongly boosted to a biocidal level by the addition of a tiny amount of isothiazolinone derivative. It will be evident to those skilled in the art that the required synergistically adequate amounts will vary depending on the particular organisms and particular application and can readily be determined by routine experimentation. Moreover, using a synergistically effective amount enables the use of a substantially smaller amount of each biocide. In fact, even at a very low concentration (0.025% w/w), 2-Octyl-2H-Isothiazol-3-one boosts the performance of silver phosphate.

### Biocidal Efficacy on Viruses

Formulations A, B, C and G have been further tested on aluminum substrate against coronaviruses coronavirus

The tests have been conducted according to test method ISO 21702 and using bovine coronavirus and Vero E6 cells. The specimens were done as previously described on rectangular aluminum plates (5 cm length, 5 cm width and 0.1 cm thickness) coated by means of a dip coater. The plates were then dried at room temperature for 24 hours. 4 test specimens each per coated and uncoated control. The inoculation consists in 400 l of virus suspension applied onto the test and control surfaces. After a contact time of 24 h at room temperature, virus suspension is recovered from the coated and uncoated test specimens; test against Bovine coronavirus have been carried out under BSL-2 conditions.

The antiviral activity of the test specimens is calculated in comparison to the G formulation (coated specimen without biocides) and performed in duplicates and two independent experiments.

### Test Results:

TABLE 3

| | Contact | | Logarithmic reduction | Antiviral |
|---|---|---|---|---|
| Sample | Time | | [log10] | efficiency |
| Formulation G | 0 | min | — | 0% |
| (reference) | 24 | h | — | 4% |
| Formulation: A | 24 | h | 0.161 | 31% reduction |
| Formulation: B | 24 | h | 0.125 | 25% reduction |
| Formulation: C | 24 | h | 0.569 | 73% reduction |
| Formulation: D | 24 | h | 0.125 | 25% reduction |
| Formulation: E | 24 | h | 0.102 | 21% reduction |
| Formulation: F | 24 | h | 0.409 | 61% reduction |

The results show that the combination ofisothiazolinone and silverphosphate synergistically work against virus and the biocidal effect is there even at a very low concentration, like in the case of formulation F.

The invention is now illustrated with the following non-limiting examples.

### EXAMPLES

### Example 1

Water-Borne with Silver and Isothiazolinone

### Opaque

TABLE 4

| Component | % w/w |
|---|---|
| Tap water | 76.80% |
| Antifoaming agent (silicone-based) | 0.30% |
| Surfactant (Surfynol 104A) | 0.65% |
| Mineral oil | 1.85% |
| Isothiazolinone | 0.30% |
| Silver phosphate glass | 2.00% |
| Sodium carboxymethyl cellulose neutralized | 0.50% |
| (Walocel CRT 20000 Dow Chemical) | |
| Kaolin | 9.60% |
| Calcium carbonate | 8.00% |

The coating solution has been prepared by first dispersing the carboxymethyl cellulose in water by means of a mixer at high shear (TDS Conti lab mixer type). Then the isothiazolinone, antifoaming agent, nonionic surfactant and mineral oil are added, and the dispersion is kept under strong stirring. After 5 minutes, the solid components are then dispersed in the solution, which is then kept under stirring for further 20 minutes.

The application of the coating solution is conducted by dip coating (dipping speed 0.3 cm/s) on rectangular polycarbonate plates (10 cm length, 15 cm width and 0.5 cm thickness). The plates were then dried at room temperature for 7 hours.

The coating adhesion was evaluated by assessing the adhesion of coating films to the substrate by applying and removing pressure-sensitive tape over a one-hundred-section grid made in the film.

The experiment has been conducted according to the test method JIS K5400. In regard to the test results, “Pass” means that no damages have been observed on the coating; conversely, “Fail” means at least one section has been damaged.

The hardness of the substrate treated with the coating formulation has been determined employing pencils and the method applied is the ASTM D3363-20.

The results show that the coating formulation provides an unexpected structural, mechanical resistance to the substrate and has excellent adhesion to the support material.

TABLE 5

| | Hardness test according | Grid |
|---|---|---|
| | to ASTM D3363-20 | Adhesion Test |
| Polycarbonate untreated | F | NA |
| polycarbonate coated | HB | PASS |
| with formulation as | | |
| per example 1 | | |

### Example 2

Water-Borne with Isothiazolinone and Silver

### Transparent

TABLE 6

| Component | % w/w |
|---|---|
| Tap water | 94.50% |
| Antifoaming agent (silicone-based) | 0.30% |
| Surfactant (Surfynol 104A) | 0.65% |
| Mineral oil | 1.85% |
| Isothiazolinone | 0.30% |
| Silver phosphate glass | 2.00% |
| Carboxymethyl cellulose neutralized | 0.50% |
| (Walocel CRT 20000 Dow Chemical) | |

The coating solution has been prepared by first dispersing the carboxymethyl cellulose in water by means of a mixer at high shear (TDS Conti lab mixer type). Then the isothiazolinone, antifoaming agent, nonionic surfactant, mineral oil are then, added and the dispersion was kept under strong stirring. After 5 minutes, silver phosphate glass is then dispersed in the solution, which is then kept under stirring for further 20 minutes.

The application of the coating solution is conducted by dip coating (dipping speed 0.3 cm/s) on rectangular polycarbonate plates (10 cm length, 15 cm width and 0.5 cm thickness). The plates were then dried at room temperature for 7 hours

The coating adhesion was evaluated by assessing the adhesion of coating films to the substrate by applying and removing pressure-sensitive tape over a one-hundred-section grid made in the film.

The experiment has been conducted according to the test method JIS K5400. In regard to the test results, “Pass” means that no damages have been observed on the coating; conversely, “Fail” means at least one section has been damaged.

The hardness of the substrate treated with the coating formulation has been determined employing pencils and the method applied is the ASTM D3363-20.

The results show that the coating formulation provides an unexpected structural, mechanical resistance to the substrate and excellent adhesion to the support material.

TABLE 7

| | Hardness test according | Grid |
|---|---|---|
| | to ASTM D3363-20 | Adhesion Test |
| Polycarbonate untreated | F | NA |
| Polycarbonate coated | HB | PASS |
| with Formulation as | | |
| per example 2 | | |

Another embodiment of this invention concerns the determination of low leaching characteristic in regard to the biocides, and more specifically, in regards to silver ions from the substrate treated with a coating formulation described in this patent application.

Critical input parameters required for estimating are the leaching rates which are, in some countries, part of the required data set for the authorization of active substances and biocidal products. However, despite the importance of the leaching rate as a parameter to characterize a coated surface, there is no harmonized set of leaching tests or appropriate methods available to calculate leaching rates for most of the applications of biocidal products in materials during their service life.

The authors of this patent application have decided to deploy the following procedure.

An aluminum plate 10 cm length, 15 cm width and 0.5 cm thickness) has been coated with the coating formulation as per example 3 by dip coating as according to the procedure previously described. The plates (5) have been dried at room temperature for 2 days and then treated in been left in boiling salty water (50 g NaCl per 11 water) for 5 hours.

The salty solution has been cooled down and titrated to determine the presence of silver ions, which would be a proof of leaching. In particular, the silver content is determined by precipitation titration with potassium thiocyanate KSCN as a titrant. The titration is monitored by a combined silver ring electrode and followed by means of a Mettler Toledo Excellence T5 17 titration device.

The silver concentration found was just above the detection threshold of the device, that means above 1 ppm, which means that the coating is virtually not leaching biocides, even under very harsh conditions.

### Example 3

Solventborne with Isothiazolinone and Silver Phosphate

### Transparent

TABLE 8

| Component | Wt % |
|---|---|
| Acrylic-vinyl toluene modified Alkyd | 22.96% |
| (Polychem 7060; EPS 2580) | |
| Dispersing agent (Dysperbyk 163) | 1.54%% |
| Defoamer (BYK 028) | 0.25% |
| N-butylacetat | 24.00% |
| Acetone | 24.00% |
| 2-methoxy-1-methylacetate | 4.00% |
| Xylene | 4.00% |
| Butanone | 4.50% |
| Diethylenglycol | 10.00% |
| 2-octyl-2h-isothiazol-3-on | 0.25% |
| Silber phosphate glass | 4.00% |

The coating solution has been prepared by first mixing the binder (acrylic vinyl binder) together with the dispersing agent and then add the N-butylacetate, acetone, 2-methoxy ethoxy-1-methylethylacetate, xylene, and butanone in the reactor under moderate stirring. At the very end, diethylenglycole and 2-octyl-2H-isothiazol-3-on are slowly added to the solution, the silver phosphate is added under vigorous stirring.

The application of the coating solution is conducted by dip coating (dipping speed 0.3 cm/s) on rectangular polycarbonate plates (10 cm length, 15 cm width and 0.5 cm thickness). The plates were then dried at room temperature for 7 hours.

### Example 4

Solventborne with Isothiazolinone and Silver Phosphate

### Transparent

TABLE 9

| Component | Wt % |
|---|---|
| Acrylic-resin | 35.96% |
| Dispersing agent (Dysperbyk 163) | 1.54%% |
| Defoamer (BYK 028) | 0.25% |
| N-butylacetate | 33.00% |
| 2-Ethyl-ethoxypropionate | 4.00% |
| Xylene | 7.00% |
| Butanone | 4.00% |
| Diethylenglycol | 10.00% |
| 2-octyl-2h-isothiazol-3-on | 0.25% |
| Silber phosphate glass | 4.00% |

The coating solution has been prepared by first mixing the binder (acrylic based) together with the dispersing agent and then add the N-butylacetate, acetone, ethyl-ethoxypropionate, xylene, and butanone in the reactor under moderate stirring. At the very end, diethylenglycole and 2-octyl-2H-isothiazol-3-on are slowly added to the solution, the silver phosphate is then added under vigorous stirring.

The application of the coating solution is conducted by dip coating (dipping speed 0.3 cm/s) on rectangular polycarbonate plates (10 cm length, 15 cm width and 0.5 cm thickness). The plates were then dried at room temperature for 7 hours.

### Example 5

Solventborne with Isothiazolinone and Silver Phosphate

### Transparent

TABLE 10

| Component | Wt % |
|---|---|
| Epoxy resin (Araldite GZ 7071 X 75) | 16.50% |
| trioleate polysorbates | 0.50% |
| N-Butylacetate | 30.00% |
| Acetone | 12.50% |
| 2-Methoxyethoxy-1-methylethylacetate | 6.00% |
| Xylene | 6.00% |
| 2-octyl-2H-isothiazol-3-on | 0.25% |
| Silver phosphate glass | 4.00% |
| Butanone | 6.00% |
| Diethylenglycole | 15.70% |

The coating solution has been prepared by first mixing N-butylacetate, acetone, 2-methoxy ethoxy-1-methylethylacetate, xylene, and butanone in the reactor under moderate stirring. At the very end, diethylenglycole and 2-octyl-2H-isothiazol-3-on are slowly added to the solution, the silver phosphate is added under vigorous stirring.

The application of the coating solution is conducted by dip coating (dipping speed 0.3 cm/s) on rectangular polycarbonate plates (10 cm length, 15 cm width and 0.5 cm thickness). The plates were then dried at room temperature for 7 hours.

The coating adhesion was evaluated by assessing the adhesion of coating films to the substrate by applying and removing pressure-sensitive tape over a one-hundred-section grid made in the film.

The experiment has been conducted according to the test method JIS K5400. In regard to the test results, “Pass” means that no damages have been observed on the coating; conversely, “Fail” means at least one section has been damaged.

The hardness of the substrate treated with the coating formulation has been determined employing pencils and the method applied is the ASTM D3363-20.

The results show that the coating formulation provides an unexpected structural, mechanical resistance to the substrate and has excellent adhesion to the support material.

TABLE 11

| | Hardness test according | Grid |
|---|---|---|
| | to ASTM D3363-20 | Adhesion Test |
| Polycarbonate untreated | F | NA |
| polycarbonate coated | HB | PASS |
| with Formulation as | | |
| per example 3 | | |

### Example 6

Water-Borne with Isothiazolinone and Silver with Waterproof Properties and Elastic

TABLE 12

| Component | % w/w |
|---|---|
| Tap water | 35.80% |
| Antifoaming agent (BYK 711) | 0.10% |
| Thickener (Natrosol 250 MBR from Aqualon) | 0.30% |
| Ammonia | About 0.10% |
| Isothiazolinone | 0.30% |
| Silver phosphate | 1.00% |
| Binder (Crilant 4706, Vynavil) | 60.00% |
| Wetting agent (Cognis Disponil TL 400) | 0.40% |
| Dispersant agent | 0.40% |
| Monopropylene glycol | 0.50% |
| Sodium hexametaphosphate | 1.10% |

The coating solution has been prepared by first thickener in water and then drop by drop ammonia. Once pH 9 is reached, all the other component are added under vigorous stirring. Solid ingredients are added first and MPG, antifoam and wetting agent afterwards.

### Example 7

Water-Borne with Isothiazolinone and Silver

### Elastic

TABLE 13

| Component | % w/w |
|---|---|
| Tap water | 65.40% |
| Antifoaming agent (BYK 711) | 0.50% |
| Surfactant (Gemini surfactant | 1.10% |
| Evonik Envirogem AD type) | |
| Mineral oil | 0.50% |
| Isothiazolinone | 0.30% |
| Silver phosphate glass | 2.00% |
| Co-solvent (Dowanol 255) | 5.00% |
| Co-wetting agent (Dysperbik 180) | 1.30% |
| Polyamine (Amyrez 148/024) | 23.90% |

The coating solution has been prepared by first dispersing the polyamine in water by means of a mixer at high shear (TDS Conti lab mixer type). Afterwards, the isothiazolinone, co-wetting agent, co-solvent, antifoaming agent, Gemini surfactant, mineral oil are added, and the dispersion is then kept under stirring. After 5 minutes, silver phosphate is then dispersed in the solution and it is then kept under stirring for further 20 minutes.

### Example 8

Water-Borne with Isothiazolinone and Silver
Elastic with TiO2, Transparent

TABLE 14

| Component | % w/w |
|---|---|
| Tap water | 65.20% |
| Antifoaming agent (BYK 711) | 0.50% |
| SurfactantGeminini surfactant | 1.10% |
| (Evonik Envirogem AD type) | |
| Mineral oil | 0.50% |
| Isothiazolinone | 0.30% |
| Silver phosphate | 2.00% |
| Co-solvent (Dowanol 255) | 5.00% |
| Co-wetting agent (Dysperbik 180) | 1.30% |
| TiO2 anatase (Kronos Clean 7050) | 0.20% |
| Polyamine (Amyrez 148/024 | 23.90% |

The coating solution has been prepared by first dispersing the polyamide in water by means of a mixer at high shear (TDS Conti lab mixer type). Afterwards, the isothiazolinone, co-wetting agent, co-solvent, antifoaming Gemini surfactant, mineral oil are added, and the dispersion is kept under stirring. After 5 minutes, titanium dioxide and silver phosphate are dispersed in the solution, which is kept under stirring for 20 minutes.

### Example 9

Water-Borne with Isothiazolinone and Silver
Elastic with 9-Cyanoanthracene (Fluorescent)

TABLE 15

| Component | % w/w |
|---|---|
| Tap water | 65.20% |
| Antifoaming agent (BYK 711) | 0.50% |
| Surfactant (Gemini surfactant | 1.10% |
| from Evonik Envirogem AD type) | |
| Mineral oil | 0.50% |
| Isothiazolinone | 0.30% |
| Silver phosphate | 2.00% |
| Co-solvent (Dowanol 255) | 5.00% |
| Co-wetteing agent (Dysperbik 180) | 1.30% |
| 9-cyanoanthracene 20% solution | 0.01% |
| in hexane (TCI chemicals) | |
| Polyamine (Amyrez 148/024 | 23.90% |

The coating solution has been prepared by first dispersing the polyamine in water by means of a mixer at high shear (TDS Conti lab mixer type). Afterwards, the isothiazolinone, co-wetting agent, co-solvent, antifoaming agent, Gemini surfactant, mineral oil are added, and the dispersion is then kept under stirring. After 5 minutes, titanium dioxide, silver phosphate and the 9-cyanoanthrancene solution are then dispersed in the solution, which is then kept under stirring for further 20 minutes.

### Example 10

Solventborne with Isothiazolinone and Silver Phosphate

### Transparent

TABLE 16

| Component | Wt % |
|---|---|
| Acrylic-resin | 28.96% |
| Dispersing agent (Dysperbyk 163) | 1.54%% |
| Defoamer (BYK 028) | 0.25% |
| N-butylacetate | 20.00% |
| Acetone | 20.00% |
| 2-methoxy-1-methylethylacetate | 4.00% |
| 2-Ethyl-ethoxypropionate | 3.00% |
| Xylene | 4.00% |
| Butanone | 4.00% |
| Diethylenglycol | 10.00% |
| 2-octyl-2h-isothiazol-3-on | 0.25% |
| Silver phosphate glass | 4.00% |

The coating solution has been prepared by first mixing the binder (acrylic) together with the dispersing agent and then add the N-butylacetate, acetone, ethyl-ethoxypropionate, 2-methoxy-1-methylethylacetate, xylene, and butanone in the reactor under moderate stirring. At the very end, defoamer, diethylenglycole and 2-octyl-2H-isothiazol-3-on are slowly added to the solution, the silver phosphate glass is then added under vigorous stirring.

The application of the coating solution is conducted by dip coating (dipping speed 0.3 cm/s) on rectangular polycarbonate plates (10 cm length, 15 cm width and 0.5 cm thickness). The plates were then dried at room temperature for 7 hours.

### Example 11

Solvent-Bases with Isothiazolinone and Silver Phosphate
Transparent with Fluorescent Porphyine

TABLE 17

| Component | Wt % |
|---|---|
| Epoxy resin (Araldite GZ 7071 X 75) | 16.50% |
| trioleate polysorbates | 0.50% |
| benzotriazole | 0.10% |
| N-Butylacetate | 30.00% |
| Acetone | 12.50% |
| 2-Methoxyethoxy-1-methylethylacetate | 6.00% |
| Xylene | 6.00% |
| 2-octyl-2H-isothiazol-3-on | 0.30% |
| Silver phosphate glass | 6.40% |
| magnesium tetraphenyl porphyrine | 0.05% |
| (dissolved toluene 10%) | |
| Butanone | 6.00% |
| Diethylenglycole | 15.70% |

The coating solution has been prepared by first mixing Epoxy resin, n-Butylacetate, methoxy ethoxy-1-methylethylacetate, xylene, and butanone in the reactor under moderate stirring. To the solution are then slowly added diethylenglycole, magnesium tetraphenyl porphyrine, 2-octyl-2H-isothiazol-3-on and at the very end the silver phosphate are added under strong stirring.

Coating formulations as per Example 6 and Example 7 have been applied on aluminum plates by dip coating (dipping speed 0.3 cm/s) on rectangular plates (10 cm length, 15 cm width and 0.5 cm thickness). The plates were then dried at room temperature for 4 hours.

To check the fluorescence effect, the coated substrates have been irradiated with a blue lamp which emits in the region 360-430 nm (Phoseon J100), and the coated substrate has shown a light coloration due to the emission spectrum of 9-caynoanthracene and magnesium tetraphenyl porphyrine.

1. A coating formulation comprising silver ions and an isothiazolinone derivative as antimicrobial agents,

2. Coating composition according to claim 1, wherein the silver ions and the isothiazolinone derivative are homogenously dispersed in a liquid matrix, and their total concentration is not more than 10% w/w of said matrix.

3. Coating composition according to claim 1, characterized in that the weight ratio silver, calculated as elemental silver, to isothiazolinone derivative is about 1:50 to 50:1, more preferably 1:10 to 10:1.

4. Coating composition according to claim 1, wherein the concentration of silver ions is from 0.02% to 8% by weight, preferably from 0.05% to 6% by weight and more preferably from 0.10% to 5%.

5. Coating composition according to claim 1, wherein the silver ions is a silver salt.

6. Coating composition according to claim 1, wherein silver ions are generated from silver carboxylates such as silver formate, silver acetate, silver oxalate, silver malonate, silver benzoate, and silver phthalate; silver fluoride, silver chloride, silver bromide, silver phosphate, silver phosphate glass, silver iodide and the like silver sulfate, silver nitrate, silver carbonate any combination of any of the foregoing.

7. Coating composition according to claim 1, wherein the silver ions is silver metallic particles.

8. Coating composition according to claim 1, wherein the concentration of isothiazolinone derivative is from 0.01% to 4% by weight, preferably from 0.010% to 1% by weight.

9. Coating composition according to claim 1, wherein the isothiazolinone derivative is 2-n-octyl-4-isothiazolinone-3-one, 2-octyl-isothiazonol-3-on, 2-octyl-2H-isothiazol-3-on, N-butyl-1,2-benzisothiazolin-3-one and 2-methyl-4,5-trimethylene-4-isothiazolin-3-one, 2-methyl-3-isothiazoline, 2-methyl-4-isothiazolin-3-one, 2-ethyl-3-isothiazoline, 2-propyl-3-isothiazoline, 2-isopropyl-3-isothiazoline, 2-butyl-3-isothiazoline (in which butyl may be n-butyl, iso-butyl or tert-butyl), 2-octyl-4-isothiazolin-3-one, 1,2-benzisothiazolin-3-one, 1,2-benzisothiazolin-3-one, salt, 5-chloro-2-methyl-3-isothiazoline, 5-chloro-2-methyl-4-isothiazolin-3-one or 4,5-dichloro-2-(n-octyl)-4-isothiazolin-3-one, and/or salts thereof.

10. Coating composition according to claim 1, wherein the content of water is from 0.5% and 65%

11. Coating composition according to claim 1, wherein the concentration is 0%.

12. Coating composition according to claim 1, wherein copper nitrate is used as stabilising agent.

13. Coating composition according to claim 12, wherein the concentration of copper nitrate is from 0.01% up to 4% weight to weight, preferably between 0.010% wt and 2.0% wt.

14. Coating composition, according to claim 1, comprising a fluorescent molecule.

15. Coating composition according to claim 11, wherein fluorescent molecule is selected from the group consisting of Fluorol green Gold, 2-Duil ASP, 4 dimethylamino 4-nitrostilbene, carboxynaphtofluorescina, zinc tetramesitylprophyrine, QpyMe2, magnesium tetraphenyl porphyrine, 9-cyanoanthracene, and coumarine 6.

16. Coating composition according to claim 11, wherein the concentration of fluorescent molecule is about 0.005% to 1%, more preferably 0.03% to 0.5%.

17. Coating composition according to claim 1, wherein the solvents comprise hexane, heptane, THF, hydrofurane, mineral oil, xylene, toluene, acetone, diethylene glycol, butanone, ester of acrylic and/or methacrylic acid with alkanols containing 1 to 12 C-atoms, vinyl chloride, vinylidene chloride, vinyl acetate, vinyl propionate, vinyl esters of versatic acid, vinyl esters of long-chain fatty acids.

18. Coating composition according to claim 1, wherein the thickening agents comprises associative thickeners like hydroxyethyl cellulose, hydroxypropyl cellulose, methylcellulose, polyethylene oxide, ethyl hydroxyethyl cellulose, carboxymethyl cellulose, guar gum, starch, starch ethers, hydrophobically modified hydroxyethyl cellulose, hydrophobically modified methylhydroxyethyl cellulose, hydrophobically modified hydroxypropyl cellulose, hydrophobically modified polyethylene glycol, hydroxyethyl starch, locust bean gum, pectin, xanthan gum, methylhydroxyethyl cellulose, polyvinylpyrolidone, polyvinyl alcohol, methylhydroxypropyl cellulose, polyacrylic acid and polyacrylate derivatives, polyurethane, nitro based, alkyd based, epoxy, polyester, vinyl, silicone or any mixture of the above.

19. Coating composition, according to claim 1, comprising titanium dioxide.

20. Coating composition according to claim 16, wherein the titanium dioxide is in its photocatalytic active crystalline form.

21. Coating composition according to claim 11, wherein the concentration of titanium dioxide is about 0.3 to 5%, more preferably 0.3% to 1.5%.

22. Coating composition according to claim 1, which shows leaching of Ag ions inferior to 0.1% of initial concentration on the substrate.

23. Coating composition according to claim 1, which is suitable to be used as aerosol paints and containing solvent or solvent and propellant.
